(19) United States
(12) Patent Application Publication
(10) Pub. No.: US 2005/0259259 A1
(43) Pub. Date: Nov. 24, 2005

(54) Photothermal conversion spectroscopic analysis method and microchemical system for implementing the method

(75) Inventors: Jun Yamaguchi, Tokyo (JP); Takashi Fukuzawa, Tokyo (JP)

Correspondence Address: FRISHAUF, HOLTZ, GOODMAN & CHICK, PC, 220 5TH AVE FL 16, NEW YORK, NY, 10001-7708, US

(73) Assignee: NIPPON SHEET GLASS COMPANY, LIMITED, Tokyo (JP)

(21) Appl. No.: 11/132,892

(22) Filed: May 18, 2005

(30) Foreign Application Priority Data
May 20, 2004 (JP) 2004-150828

(51) Int. Cl. G01N 21/61

(52) U.S. Cl. 356/432

(57) ABSTRACT

A photothermal conversion spectroscopic analysis method which is capable of performing analysis, measurement and detection with high sensitivity. A sample flows in a channel. A exciting light and a detecting light are exited. A gradient refractive index rod lens converges the exited light and forms a focal point at a position in or close to the channel. Intensity of the exited light and passing through the channel are detected. A depth of the channel is not less than two time as large as a difference in distance between focal positions of the exciting light and the detecting light.

### BACKGROUND OF THE INVENTION

1. Field of the Invention

The present invention relates to a photothermal conversion spectroscopic analysis method and a microchemical system for implementing the method, that convergently irradiate exciting light and detecting light into a sample in a solution to form a thermal lens in the sample by the exciting light and measure the detecting light passing through the thermal lens, and in particular, to a photothermal conversion spectroscopic analysis method and a microchemical system for implementing the method, that allow high-precision ultramicroanalysis to be carried out in a very small space and allow measurement to be carried out conveniently in any chosen location.

2. Description of the Related Art

In recent years, a spectroscopic analysis method has been widely utilized as a method for analyzing or detecting semiconductors, biological samples, and various kinds of liquid samples. However, when a very small amount of substance or a very small substance is analyzed in a very small space by the conventional spectroscopic analysis method, there are problems that a vacuum is required as one of measurement conditions and that a sample is broken or damaged by the use of an electron beam or an ion beam.

When an extremely small amount of sample in a solution or a biological tissue is handled, it is essentially required to use an optical microscope capable of analyzing the sample with a high spatial resolution and with high accuracy. What is actually used as such an optical microscope is limited to a laser fluorescent microscope. Hence, it is natural that objects to be analyzed are limited to laser fluorescent microscope fluorescent molecules.

Further, at present, from the viewpoint of the rapidity of chemical reactions, reactions using very small amounts of samples, on-site analysis and so on, an integration technology for carrying out chemical reactions in a very small space has attracted attention, and research has been carried out vigorously throughout the world.

The so-called microchemical system is one example of such integration technology. In the microchemical system, a sample solution is mixed, reacted, separated, extracted, or detected in a very fine channel formed in a small glass substrate or the like. Examples of reactions carried out in such a microchemical system include diazotization reactions, nitration reactions, and antigen-antibody reactions. Moreover, examples of extraction/separation include solvent extraction, electrophoretic separation, and column separation. The microchemical system may be used to perform a single function, for example, for only separation, or may be used to perform a plurality of functions in combination.

As an example of the microchemical system for only separation out of the above functions, an electrophoresis apparatus for analyzing extremely small amounts of proteins, nucleic acids or the like has been proposed (see, for example, Japanese Laid-open Patent Publication (Kokai) No. H8-178897). This electrophoresis apparatus has a channel-formed plate-shaped member composed of two glass substrates joined together. Because the member is plate-shaped, breakage is less likely to occur than in the case of a glass capillary tube having a circular or rectangular cross section, and hence handling is easier.

In such a microchemical system, a photothermal conversion spectroscopic analysis method that uses a thermal lens effect caused by a photothermal conversion phenomenon has attracted attention as an analysis method capable of analyzing a sample with high accuracy and high spatial resolution and without using a vacuum field and in such a manner that the sample is kept out of contact with any component part of the system and hence is not damaged, and capable of analyzing samples other than fluorescent molecules.

This photothermal conversion spectroscopic analysis method uses a photothermal conversion effect that when light is convergently irradiated into a sample solution, the light is absorbed by a solute in the sample solution to release thermal energy, and thus the temperature of the solvent is locally raised by this thermal energy, whereby the refractive index of the sample solution changes, and hence a thermal lens is formed.

FIG. 2 is a view useful in explaining the principle of a thermal lens.

In FIG. 2, exciting light is convergently irradiated into an extremely small amount of sample solution via an objective lens, whereby a photothermal conversion effect is brought about. For most substances, the refractive index drops as the temperature rises, and hence in the sample solution into which the exciting light has been convergently irradiated, the refractive index drops, with the drop being larger the closer to the center of the converged light, which is where the rise in temperature is largest, and the rise in temperature becomes smaller with distance from the center of the converged light due to thermal diffusion. Optically, the resulting refractive index distribution produces the same effect as a concave lens, and hence the effect is referred to as the thermal lens effect. The magnitude of the thermal lens effect, i.e. the power of the concave lens, is proportional to the optical absorbance of the sample solution. Moreover, in the case where the refractive index increases with temperature, a convex lens is formed.

In the photothermal conversion spectroscopic analysis method described above, changes in the temperature, i.e. changes in the refractive index are thus observed, and hence the method is suitable for detecting the concentrations of extremely small samples.

An example of a photothermal conversion spectroscopic analysis apparatus that carries out the photothermal conversion spectroscopic analysis method described above is disclosed in Japanese Laid-open Patent Publication (Kokai) No. H10-232210. In the conventional photothermal conversion spectroscopic analysis apparatus, a sample is disposed below the objective lens of a microscope, and exciting light of a predetermined wavelength outputted from an exciting light source is introduced into the microscope. The exciting light is thus convergently irradiated via the objective lens of the microscope into a region of an extremely small amount of the sample. A thermal lens is thus formed in a manner centered at the position on which the exciting light is convergently irradiated.

On the other hand, detecting light outputted from a detecting light source and having a wavelength different from that of the exciting light is introduced into the microscope. The detecting light exiting from the microscope is convergently irradiated into the thermal lens that has been formed in the sample by the exciting light, and passes through the sample and is thus diverged or converged. The diverged or converged detecting light exiting from the sample solution acts as signal light. The signal light-passes through a convergent lens and a filter, or just a filter, and is detected by a detector. The intensity of the detected signal light depends on the thermal lens formed in the sample.

The detecting light may have the same wavelength as the exciting light, or the exciting light may also be used as the detecting light. However, in general, when the exciting light is different in wavelength from the detecting light, more excellent sensitivity can be obtained.

However, in the conventional photothermal conversion spectroscopic analysis apparatus described above, the optical system including the light sources, the measurement section, and the detection section (photoelectric conversion section) has a complex construction, and hence such an apparatus has been large in size and has thus lacked portability. Consequently, there is a problem that there are limitations with regard to the installation site and the operation of analysis and chemical reactions using the photothermal conversion spectroscopic analysis apparatus.

Where the photothermal conversion spectroscopic analysis method is carried out using the thermal lens, it is necessary for the focal position of the exciting light and the focal position of the detecting light to be different from each other. FIG. 3A shows the formation position of a thermal lens and the focal position of detecting light in the direction of the optical axis of exciting light (in the direction of the Z axis) in a case in which an objective lens has chromatic aberration, and FIG. 3B shows the formation position of a thermal lens and the focal position of detecting light in the direction of the optical axis of exciting light (in the direction of the Z axis) in a case in which the objective lens does not have chromatic aberration.

In the case where the objective lens 130 has chromatic aberration, as shown in FIG. 3A, the thermal lens 131 is formed at the focal position 132 of the exciting light, and the focal position 133 of the detecting light is in a position shifted by an amount ΔL from the focal position 132 of the exciting light, so that changes in the refractive index of the thermal lens 131 can be detected as changes in the focal distance of the detecting light. On the other hand, in the case where the objective lens 130 does not have chromatic aberration, as shown in FIG. 3B, the focal position 133 of the detecting light is almost exactly the same as the position of the thermal lens 131 formed at the focal position 132 of the exciting light. As a result, the detecting light is not refracted by the thermal lens 131, and hence changes in the refractive index of the thermal lens 131 cannot be detected.

However, the objective lens of a microscope is generally manufactured so as not to have chromatic aberration, and hence for the reason described above, the focal position 133 of the detecting light is almost exactly the same as the position of the thermal lens 131 formed at the focal position 132 of the exciting light (FIG. 3B), so that changes in the refractive index of the thermal lens 131 cannot be detected. There is thus a problem that the position of the sample in which the thermal lens 131 is formed must be shifted from the focal position 133 of the detecting light every time measurement is carried out, as shown in FIGS. 4A and 4B, or else the detecting light must be slightly diverged or converged using a lens (not shown) before being introduced into the objective lens 130 so that the focal position 133 of the detecting light is shifted from the thermal lens 131 as shown in FIG. 5, which results in degraded work efficiency of the user.

Further, conventionally, in the photothermal conversion spectroscopic analysis, a method for detecting light with high sensitivity has not been proposed, which makes it impossible to design the measurement sensitivity, and hence a microchemical system of high performance cannot be manufactured with stability.

### SUMMARY OF THE INVENTION

It is an object of the present invention to provide a photothermal conversion spectroscopic analysis method which is capable of performing analysis, measurement and detection with high sensitivity, and a small-sized microchemical system for implementing the method.

To attain the above object, according to the first aspect of the present invention, there is provided a microchemical system comprising a channel through which a sample flows, a light exiting device that exits two kinds of light of different wavelengths, a light converging lens that converges the light exited from the light exiting device and forms a focal point at a position in or close to the channel, and a detecting device that detects intensity of the light exited from the light exiting device and passing through the channel, wherein a depth of the channel is not less than two time as large as a difference in distance between focal positions of the two different kinds of lights.

With the arrangement of the first aspect of the present invention, the depth of the channel through which the sample to be detected flows should be not less than two times as large as the difference in focal position between the exciting light and the detecting light, whereby sufficient signal intensity can be obtained and hence the sample can be detected with high sensitivity. As a result, it is possible to carry out measurements on microscopic reactions that cannot be measured by the conventional methods.

Preferably, the light converging lens has chromatic aberration.

According to the above construction, the light converging lens has chromatic aberration, so that it is possible to omit an optical system for adjusting the focal positions of the exciting light and the detecting light to thereby reduce the size of the microchemical system.

Preferably, the light converging lens is a rod lens.

According to the above construction, the light converging lens is a rod lens and hence the light converging lens can be reduced in size and can be disposed closer to the channel. As a result, it is possible to further reduce the size of the microchemical system.

Preferably, the microchemical system comprises an optical fiber, and the light exiting device and the light converging lens are combined with each other by the optical fiber.

According to the above construction, an optical fiber is used as a light guiding path for guiding the exciting light and the detecting light to the light converging lens, so that it is not necessary to adjust the optical paths of the exciting light and the detecting light every time measurements are carried out, to thereby increase the working efficiency of a user. In addition, it is not necessary to provide a jig for adjusting the optical path to thereby reduce the size of the microchemical system. In the case where the exciting light and the detecting light are transmitted by a single optical fiber, the exciting light and the detecting light are always made coaxial, so that it is not necessary to provide a jig for adjusting the optical axis, whereby the microchemical system can be further reduced in size.

Preferably, the optical fiber is a single-mode fiber.

According to the above construction, a single-mode optical fiber is used and hence a thermal lens produced by the exciting light is small in size and have small aberration, which makes it possible to detect the sample with more precision.

To attain the above object, according to the second aspect of the present invention, there is provided a photothermal conversion spectroscopic analysis method comprising the steps of convergently irradiating exciting light into a fluid to be analyzed to form a thermal lens in the fluid, convergently irradiating detecting light into the thermal lens, and measuring intensity of the detecting light passing through the thermal lens, wherein a difference in distance between focal positions of the exciting light and the detecting light is not more than half of depth of the fluid.

The above and other objects, features, and advantages of the invention will become more apparent from the following detailed description taken in conjunction with the accompanying drawings.

### BRIEF DESCRIPTION OF THE DRAWINGS

FIG. 1 is a schematic view showing the entire construction of a microchemical system according to an embodiment of the present invention;

FIG. 2 is a view useful in explaining the principle of a thermal lens;

FIG. 3A shows a view useful in explaining the formation position of a thermal lens and the focal position of detecting light in the direction of the optical axis of exciting light (in the direction of the Z axis) in a case in which an objective lens has chromatic aberration;

FIG. 3B shows a view useful in explaining the formation position of a thermal lens and the focal position of detecting light in the direction of optical axis of exciting light (in the direction of the Z axis) in a case in which the objective lens does not have chromatic aberration;

FIG. 4A shows a view useful in explaining the formation position of a thermal lens and the focal position of detecting light in the direction of the optical axis of exciting light (in the direction of the Z axis) in a case in which the thermal lens is formed closer to the objective lens than is the focal position of the detecting light;

FIG. 4B shows a view useful in explaining the formation position of a thermal lens and the focal position of detecting light in the direction of the optical axis of exciting light (in the direction of the Z axis) in a case in which the thermal lens is formed in a position farther from the objective lens than is the focal position of the detecting light;

FIG. 5 is a view useful in explaining a method of detecting changes in refractive index of a thermal lens in a conventional photothermal conversion analysis apparatus, and shows a case in which a concave lens is put in an optical path so that detecting light is made into divergent light, and hence the focal position of the detecting light is made to be further away than the focal position of exciting light;

FIG. 6 shows the relationship between the depth of a channel formed in a plate-shaped member and the signal intensity of a thermal lens in a case in which a light converging lens having a chromatic aberration of 37 μm is used; and

FIG. 7 shows the relationship between the depth of a channel formed in a plate-shaped member and the signal intensity of a thermal lens in a case in which a light converging lens having a chromatic aberration of 20 μm is used.

### DETAILED DESCRIPTION OF THE PREFERRED EMBODIMENTS

The present invention will now be described with reference to the drawings showing a preferred embodiment thereof.

As a result of assiduous studies, the present inventors have found that in the photothermal conversion spectroscopic analysis method to be applied to a microchemical system, the intensity of detecting light depends on the relationship between the difference in focal position between exciting light and detecting light and the depth of a channel.

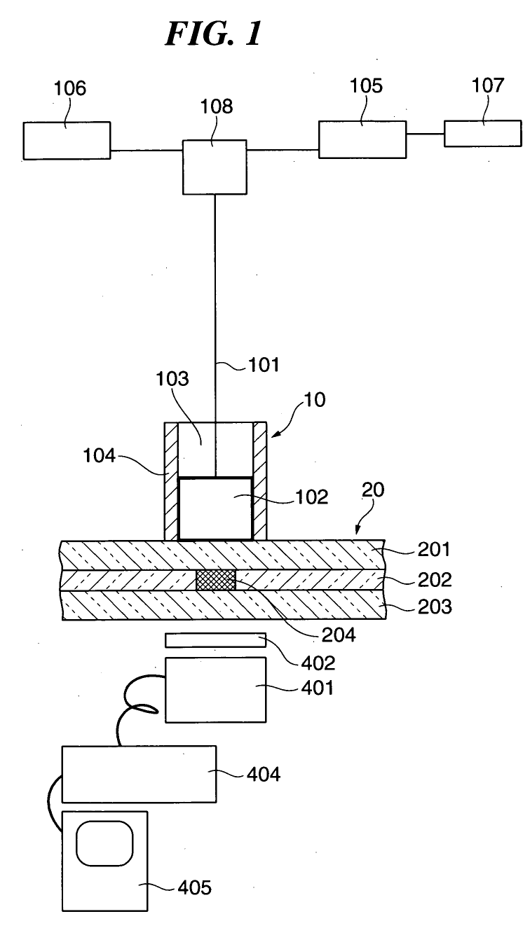

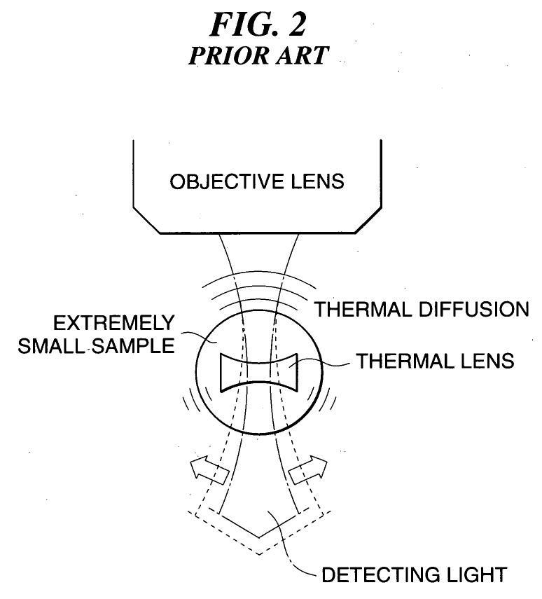

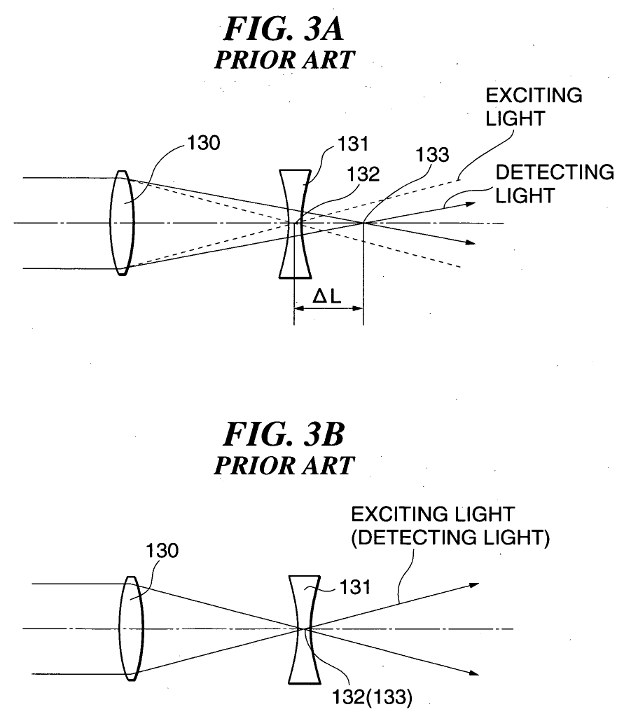

FIG. 1 is a schematic view showing the entire construction of a microchemical system according to an embodiment of the present invention. In FIG. 1, the microchemical system has an optical fiber 10 having a lens built therein (hereinafter referred to as the “optical fiber with lens 10”). The optical fiber with lens 10 has an optical fiber 101 inserted therein from a rear end thereof (the upper side as viewed in FIG. 1), for propagating exciting light and detecting light in a single mode. The end of the optical fiber 101 inserted in the optical fiber with lens 10 is connected to one end of a gradient refractive index rod lens 102. To make the outside diameter of the optical fiber 101 equal to the outside diameter of the gradient refractive index rod lens 102, a ferrule 103 having an outside diameter equal to the outside diameter of the gradient refractive index rod lens 102 is provided so as to surround the optical fiber 101. The optical fiber 101 is fixed in position by the ferrule 103, and the gradient refractive index rod lens 102 and the ferrule 103 are fixed inside a tube 104. Here, the optical fiber 101 and the gradient refractive index rod lens 102 may be in close contact with each other, or there may be a gap therebetween. The optical fiber with lens 10 is fixed on a surface of a channel-formed plate-shaped member 20, described below, in a position facing a channel 204 formed in the member 20. The optical fiber with lens 10 may be bonded directly to the channel-formed plate-shaped member 20 by an adhesive or may be fixed by a jig. Further, the optical fiber with lens 10 may be fixed in a manner separated from the channel-formed plate-shaped member 20 by a jig (not shown). Examples of adhesives that can be used to bond the optical fiber with lens 10 to the channel-formed plate-shaped member 20 include organic adhesives such as acrylic adhesives and epoxy adhesives, for example, an ultraviolet-curing type, a thermosetting type, or a two-liquid-curing type, and inorganic adhesives. The lens 102 is not limited to a gradient refractive index rod lens insofar as it has a predetermined chromatic aberration.

The gradient refractive index rod lens 102 is a transparent cylindrical lens, and is configured such that the refractive index changes continuously in a radial direction from the position of a central axis thereof that extends in a longitudinal direction thereof. Such a rod lens is known as a converging light-transmitting body configured such that the refractive index n(r) at a position a distance r in the radial direction from the central axis is given approximately by the quadratic equation for r,
n(r)=n₀{1−(g²/2)×r²},
wherein n₀ represents the refractive index at the central axis, and g represents a quadratic distribution constant.

If the total length z₀ of the gradient refractive index rod lens 102 is chosen to be in a range of 0<z₀<π/2 g, then even though the gradient refractive index rod lens 102 has flat end faces, the gradient refractive index rod lens 102 will have the same image formation characteristics as an ordinary convex lens; when a parallel light beam is incident on the gradient refractive index rod lens 102, a focal point will be formed at a position a distance so from the end of the gradient refractive index rod lens 102 from which the light beam exits, where
s₀=cot(gz₀)/n₀g.

Because the base of the gradient refractive index rod lens 102 is flat, the lens 102 can be easily attached to the end face of the optical fiber 101, and the optical axis of the gradient refractive index rod lens 102 and the optical axis of the optical fiber 101 can be easily aligned with each other. Moreover, because the gradient refractive index rod lens 102 is cylindrical, the optical fiber with lens 10 can also easily be formed in a cylindrical shape.

A single-mode optical fiber is used as the optical fiber 101 because in the case of detecting a very small amount of solute in a sample using the photothermal conversion spectroscopic analysis method, it is desirable that the exciting light will be narrowed down as much as possible to increase the energy used in the photothermal conversion and moreover to make the thermal lens produced by the exciting light have little aberration.

The light exiting from the single-mode optical fiber 101 will always have a Gaussian distribution, and hence the focal point of the exciting light will be small in size. Moreover, in the case where the thermal lens produced by the exciting light is small in size, to make the amount of the detecting light that passes through the thermal lens be as large as possible, it is preferable to also narrow down the detecting light as much as possible. From this standpoint as well, it is preferable for the optical fiber to propagate the exciting light and the detecting light in a single mode.

As the optical fiber 101, any type of optical fiber can be used insofar as it can transmit the exciting light and the detecting light. However, in the case where a multi-mode optical fiber is used, the exiting light will not have a Gaussian distribution, and moreover the pattern of the exiting light will vary according to various conditions such as the state of curvature of the optical fiber 101, and hence it will not necessarily be possible to obtain stable exiting light. Carrying out measurement on a very small amount of solute will thus be difficult, and moreover there may be a lack of stability in the measured value. It is thus preferable for the optical fiber 101 to be a single-mode optical fiber as described above.

If the leading end of the optical fiber were processed into a spherical shape or the like to form a lens, then it would be possible to narrow down the exciting light and the detecting light without installing a separate lens at the leading end of the optical fiber. However, in this case, there would be hardly any chromatic aberration, and hence the focal positions of the exciting light and the detecting light would be almost the same as each other. There would thus be a problem of the thermal lens signal being hardly detectable. Moreover, other aberration would be high for the lens formed by processing the leading end of the optical fiber, and hence there would also be a problem of the focal points of the exciting light and the detecting light being large. In the present embodiment, a gradient index rod lens 102 is thus installed to the leading end of the optical fiber 101.

At the other end of the optical fiber 101 are provided an exciting light source 105, a detecting light source 106, a modulator 107 for modulating the exciting light source, and a two-wavelength multiplexing device 108 for multiplexing the exciting light and the detecting light to be introduced into the optical fiber 101. It should be noted that the exciting light and the detecting light may be multiplexed using a dichroic mirror in place of the two-wavelength multiplexing device 108 and the multiplexed light may be then introduced into the optical fiber 101.

The channel-formed plate-shaped member 20, through which a sample to be detected is passed, is comprised of three glass substrates 201, 202, and 203 superimposed one upon another, for example, in three layers and bonded together. The channel 204, through which the sample is passed when carrying out mixing, agitation, synthesis, separation, extraction, detection or the like, is formed in the glass substrate 202.

From the perspective of durability and chemical resistance, the material of the channel-formed plate-shaped member 20 is preferably a glass. In particular, considering usage for biological samples such as cells, for example, in DNA analysis, a glass having high acid resistance and alkali resistance is preferable, specifically, a borosilicate glass, a soda lime glass, an aluminoborosilicate glass, a quartz glass or the like. However, if the usage is limited accordingly, then an organic material such as a plastic may be used instead.

Examples of adhesives that can be used to bond the glass substrates 201, 202 and 203 together include organic adhesives such as acrylic adhesives and epoxy adhesives, for example, an ultraviolet-curing type, a thermosetting type, or a two-liquid-cured type, and inorganic adhesives. Alternatively, the glass substrates 201, 202, and 203 may be fused together by heat fusion.

A photoelectric converter 401 for detecting the detecting light, and a wavelength filter 402 that separates the exciting light from the detecting light and selectively transmits only the detecting light, are provided in a position facing the optical fiber with lens 10 and facing the channel 204. A member having a pinhole formed therein for selectively transmitting only part of the detecting light may be also provided such that the pinhole is positioned in the optical path of the detecting light in a position upstream of the photoelectric converter 401.

Signals obtained by the photoelectric converter 401 are sent to a lock-in amplifier 404 so as to be synchronized with the modulator 107 used for modulating the exciting light, and are then analyzed by a computer 405.

The focal position of the exciting light exiting from the gradient refractive index rod lens 102 is preferably located in the channel 204 of the channel-formed plate-shaped member 20. The gradient refractive index rod lens 102 does not have to be in contact with the channel-formed plate-shaped member 20, but in the case where the gradient refractive index rod lens 102 is in contact with the channel-formed plate-shaped member 20, the focal distance of the gradient refractive index rod lens 102 can be adjusted through the thickness of the upper glass substrate 201 of the channel-formed plate-shaped member 20. In the case where the thickness of the upper glass substrate 201 is insufficient, a spacer for adjusting the focal distance may be inserted between the gradient refractive index rod lens 102 and the upper glass substrate 201.

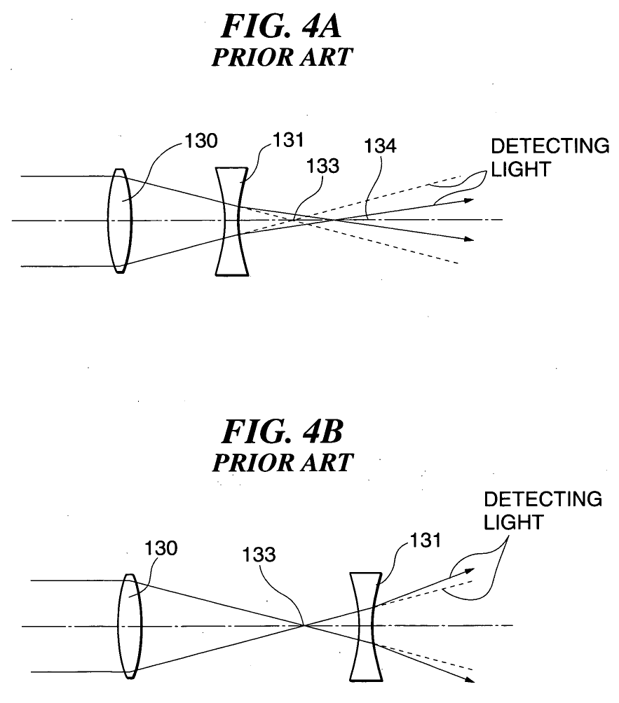

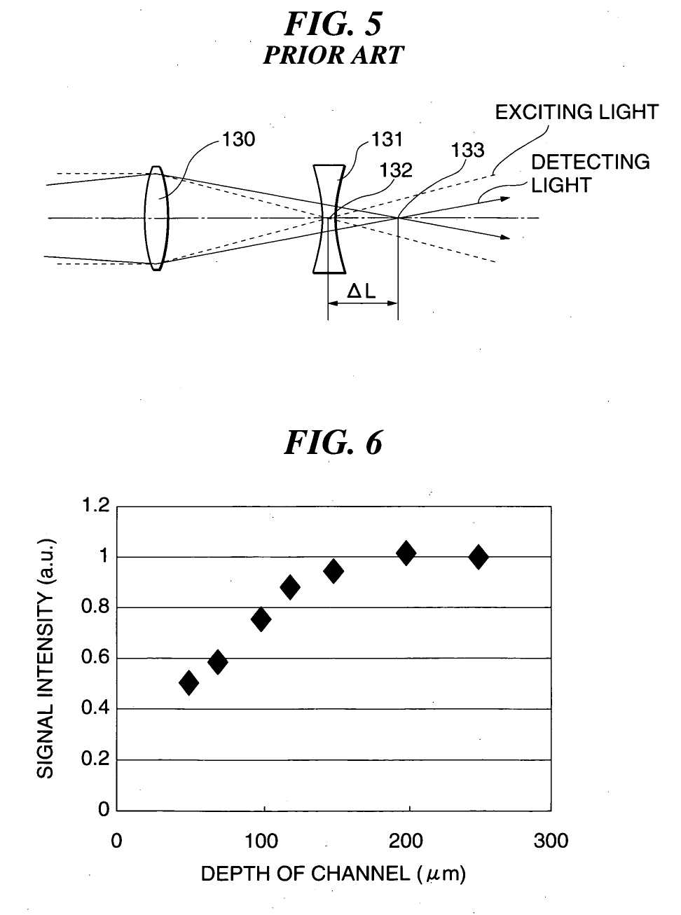

The gradient refractive index rod lens 102 is set such that the focal position of the detecting light is shifted slightly by an amount ΔL relative to the focal position of the exciting light (see FIG. 4A).

The confocal length Ic (nm) is given by Ic=π×(d/2)²/λ₁. Here, d represents an Airy disc and is given by d=1.22×λ₁/NA, where λ₁ represents the wavelength (nm) of the exciting light and NA represents the numerical aperture of the gradient refractive index rod lens 102. In the case of using an optical fiber, the numerical aperture of the light exiting from the optical fiber is small, and hence the numerical aperture of the optical fiber needs to be taken into consideration in the calculation of the confocal length when using a rod lens having a large numerical aperture.

When carrying out measurements on a sample having a thickness smaller than the confocal length, it is most preferable for the value ΔL to be equal to √3×Ic. The value ΔL represents the difference between the focal position of the detecting light and the focal position of the exciting light, and hence the result is the same regardless of whether the focal distance of the detecting light is longer or shorter than the focal distance of the exciting light.

The channel 204 formed in the plate-shaped member 20 used for the microchemical system has a depth of 50 μm to 100 μm. The reason for this is as follows. In the microchemical system, a sample solution is mixed, reacted, separated, extracted, or detected in the fine channel formed in the plate-shaped member, so that the microchemical system has advantages of being capable of reducing the amount of a sample to be used, reacting the sample at high speeds, and reducing the size of the apparatus as compared with a common chemical operation using a beaker or the like. Among these advantages, the increase of the reaction speed will be described in detail. Among reactions bringing about specific advantages by using the microchemical system is a liquid-liquid interface reaction in which the reaction progresses via an interface. In this reaction, reactants included in the respective solutions are brought into contact with each other at the interface, whereby the reaction progresses. The reaction occurs only at the interface and hence the reaction rate is determined by a rate at which each of the reactants in the respective solutions can reach the interface. Hence, a specific interface area (ratio of the interface to the volume of a solution) is important. In the microchemical system, the interface can be formed along the channel and hence a very large specific interface area can be provided as compared with the reaction in a beaker or the like. Consequently, the reaction speed can be increased. To increase the reaction speed by increasing the specific interface area, it is important to decrease the depth of the solution from the interface, that is, the width of the channel. However, in a wet etching method or the like used as the method for making a channel in the current microchemical system, the aspect ratio of the channel that can be formed (the ratio between the width and depth of the channel) is limited, so that only the width of the channel cannot be controlled separately from the depth of the channel but the depth of the channel also needs to be decreased so as to narrow the width of the channel.

From the above described fact, it is clear that the depth of the channel should be smaller so as to increase the reaction speed. However, when the depth of the channel is too small, there arise problems that the liquid cannot maintain its properties in the channel and that it is difficult to put the liquid into the channel. Hence, channels having a depth of approximately 50 μm to 100 μm are used in many cases. If the photothermal conversion spectroscopic analysis method is carried out in a state where a solution containing a substance to be detected flows in the channel configured as above, the thickness of the sample is very large for the confocal length of the exciting light. For example, in the case of converging the exciting light having a wavelength of 658 nm by an objective lens having an NA (numerical aperture) of 0.25, the confocal length is 12.3 μm and the thickness of the channel becomes not less that 4 times as large as the confocal length. When the substance to be detected is thus thick relative to the confocal length, there is brought about the same state as a state in which many layers of samples which are thin relative to the confocal length and form respective thermal lenses are laminated, and hence the area of a region where a thermal lens is formed by a thick sample finally becomes as large as the integrated value of the area of regions where thermal lenses are formed by thin samples, so that an optimal value of deviation in the focal position between the exciting light and the detecting light when the thermal lens is formed by a thick sample becomes larger as compared with when the thermal lens is formed by a thin sample.

When such a light converging lens having a large deviation in the focal position is used, the focal position of the exciting light is separated by a large amount from the focal position of the detecting light and hence the results of the photothermal conversion spectroscopic analysis and measurement further undergoes the effect of a component in the direction of depth of the thermal lens formed by the exciting lens. For this reason, in the photothermal conversion spectroscopic analysis and measurement, the greater the depth of a channel to be used, the greater the signal intensity to be obtained, so that it is desirable for the depth of the channel to be greater. However, as described above, as regards the relationship between the reaction rate and the depth of the channel, it is desirable that the depth of channel be smaller. Therefore, taking these two facts into consideration, it is desirable that the depth of the channel should be not less than two times, more preferably not less than three times, as large as the chromatic aberration, that is, the difference in focal position between the exciting light and the detecting light.

While a case of making an isotropic channel by wet etching has been described above, when an anisotropic channel is formed by a method other than the wet etching method (for example, mechanical grinding, anisotropic etching using masking, and dry etching), the width and depth of the channel should be designed such that the sectional area of the channel along a plane vertical to the surface of a microchemical chip forming the microchemical system ranges from 10×10⁵ μm² to 1.0×10⁵ μm². If the sectional area of the channel is within the above range, it is possible to obtain a reaction rate and characteristics that allow functions as a microchemical chip to be exhibited.

While the present inventors have found that in the photothermal conversion spectroscopic analysis and measurement, the intensity of the detecting light depends on the difference in focal position between the exciting light and the detecting light and the depth of the channel, to apply the photothermal conversion spectroscopic analysis and measurement to the microchemical system, as described above, the appropriate depth of the channel is determined from the relationship between the depth of the channel and the reaction rate. In other words, it is necessary to design the microchemical system in consideration of three factors of the wavelengths of the exciting light and the detecting light, the depth of the channel, and required detection intensity. It is preferable that the wavelengths of the exciting light and the detecting light used in the microchemical system should be 400 nm to 1000 nm and that the depth of the channel should be 50 μm to 100 μm from the viewpoint of the reaction rate. From these conditions, to obtain a sufficient detection intensity and a sufficient reaction rate, it is most preferable that the depth of the channel should be approximately 2 to 4 times as large as the difference in focal position between the exciting light and the detecting light.

Now, the extent of chromatic aberration that can be obtained by using a gradient refractive index rod lens will be described by way of example. As the gradient refractive index rod lens, for example, a lens SLW described in a SELFOC™ lens catalog issued by Nippon Sheet Glass Co., Ltd. can be used.

When the material of the channel-formed plate-shaped member is a Pyrex (registered trademark) Glass, the thickness above the channel (thickness of the upper glass 201) is 0.9 mm, the depth of the channel is 0.1 mm, the diameter of the gradient refractive index rod lens SLW is 1 mm, the length of the rod lens is 2.3 mm, the wavelength of the exciting light is 658 nm, the wavelength of the detecting light is 785 nm, and the focal position of the exciting light is at the center of the channel, the obtained difference (ΔL) in focal position is 37 μm.

The results obtained by measuring the relationship between the depth of the channel formed in the plate-shaped member and the signal intensity of the thermal lens by using this rod lens as a light converging lens are shown in FIG. 6. These measurement results were obtained under the following conditions.

As a sample to be measured, an aqueous solution obtained by dissolving nickel-phthalocyanine tetrasodium sulfonate at a concentration of 10⁻⁵ mol/l was placed in each of channels formed in the plate-shaped member and having respective depths, and measurements were conducted in a state where the aqueous solution was held from flowing. The wavelength of the exciting light was 658 nm, the wavelength of the detecting light was 785 nm, and the modulation speed of the exciting light was 1 kHz, and measurements were conducted in a state where the focal position of the exciting light was fixed at the center of the channel.

As shown in FIG. 6, it is when the depth of the channel formed in the plate-shaped member is 160 μm or more that the signal intensity becomes a maximum value, and this depth corresponds to approximately 4.3 times as large as the chromatic aberration of the light converging lens used. It is when the depth of the channel formed in the plate-shaped member is 120 μm (which corresponds to approximately 3.2 times as large as the chromatic aberration of the light converging lens) that the signal intensity becomes 0.9 times as large as the maximum value. Further, it is when the depth of the channel formed in the plate-shaped member is 75 μm (which corresponds to approximately 2 times as large as the chromatic aberration of the light converging lens) that the signal intensity becomes 0.6 times as large as the maximum value.

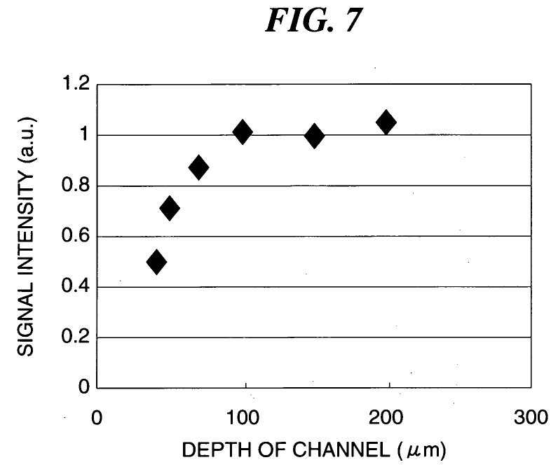

The chromatic aberration of the gradient refractive index rod lens SLW described above can be adjusted by combining the lens SLW with another gradient refractive index rod lens. A light converging lens having a chromatic aberration of 20 μm was prepared by combining the SLW lens with a lens corresponding to SLA 12 described in the SELFOC™ lens catalog issued by Nippon Sheet Glass Co., Ltd. and using this light converging lens, measurements were conducted on the relationship between the depth of the channel formed in the plate-shaped member and the signal intensity of the thermal lens, and the measurement results are shown in FIG. 7.

As shown in FIG. 7, it is when the depth of the channel formed in the plate-shaped member is 100 μm or more that the signal intensity becomes a maximum value, and this depth corresponds to approximately 5 times as large as the chromatic aberration of the light converging lens used. It is when the depth of the channel formed in the plate-shaped member is 70 μm (which corresponds to approximately 3.5 times as large as the chromatic aberration of the light converging lens) that the signal intensity becomes 0.9 times as large as the maximum value. Further, it is when the depth of the channel formed in the plate-shaped member is 40 μm (which corresponds to approximately 2 times as large as the chromatic aberration of the light converging lens) that the signal intensity becomes 0.5 times as large as the maximum value.

As is learned from the above measurement results, from the standpoint of the increase of the reaction rate, it is more preferable that the depth of the channel used in the microchemical system should be smaller, but when the depth is made too small, there is a problem that the signal intensity of the thermal lens decreases and hence the detection sensitivity becomes degraded. For this reason, the depth of the channel should be not less than two times as large as the chromatic aberration of the light converging lens, that is, the difference in focal position between the exciting light and the detecting light, so that the signal intensity of the thermal lens can be made not less than 0.5 times as large as the maximum value. By thus setting the depth of the channel, it is possible to obtain a detection intensity large enough to perform photothermal conversion spectroscopic analysis and measurement with the reaction rate kept at a large rate. When the analysis or measurement is performed with a high reaction rate or when a high reaction rate is not required in performing the analysis or measurement, the depth of the channel used in the microchemical system may be made not less than three times as large as the difference in focal position between the exciting light and the detecting light of the light converging lens. In these cases, the reaction rate is made slightly smaller but the signal intensity of the thermal lens can be made not less than 0.7 times as large as the maximum value and hence the detection sensitivity can be further enhanced.

According to the present embodiment, the plate-shaped member is provided with a channel having a depth suitable for the chromatic aberration of the gradient refractive index rod lens used as the light converging lens, and therefore, it is possible to perform measurements with high sensitivity. Moreover, it is not necessary to separately provide an optical system for adjusting the focal position of the exciting light or the detecting light, and hence it is possible to reduce the size of the apparatus.

The present invention can be applied to a microchemical system capable of detecting the reaction of a very small amount of sample flowing in a fine channel and a photothermal conversion spectroscopic analysis method applied to the microchemical system.

1. A microchemical system comprising:
a channel through which a sample flows;
a light exiting device that exits two kinds of light of different wavelengths;
a light converging lens that converges the light exited from said light exiting device and forms a focal point at a position in or close to said channel; and
a detecting device that detects intensity of the light exited from said light exiting device and passing through said channel,
wherein a depth of the channel is not less than two time as large as a difference in distance between focal positions of the two different kinds of light.

2. A microchemical system as claimed in claim 1, wherein the light converging lens has chromatic aberration.

3. A microchemical system as claimed in claim 1, wherein the light converging lens is a rod lens.

4. A microchemical system as claimed in claim 1, comprising an optical fiber, and wherein the light exiting device and the light converging lens are combined with each other by said optical fiber.

5. A microchemical system as claimed in claim 4, wherein said optical fiber is a single-mode fiber.

6. A photothermal conversion spectroscopic analysis method comprising the steps of:
convergently irradiating exciting light into a fluid to be analyzed to form a thermal lens in the fluid;
convergently irradiating detecting light into the thermal lens; and
measuring intensity of the detecting light passing through the thermal lens,
wherein a difference in distance between focal positions of the exciting light and the detecting light is not more than half of depth of the fluid.
